(19) United States
(12) Patent Application Publication
(10) Pub. No.: US 2019/0262223 A1
(43) Pub. Date: Aug. 29, 2019

(54) THERAPEUTIC VIBRATION DEVICE AND METHOD OF USE THEREOF

(71) Applicant: BIPRI, LLC, Brentwood, TN (US)

(72) Inventor: Charlie B. Mitchell, JR., Brentwood, TN (US)

(21) Appl. No.: 15/908,067

(22) Filed: Feb. 28, 2018

(51) Int. Cl. A61H 23/02; A61H 7/00

(52) U.S. Cl. CPC A61H 23/02; A61H 7/006; A61H 2201/5097; A61H 2201/1604; A61H 2201/5023; A61H 2205/02

(57) ABSTRACT

A therapeutic vibration device includes a body with at least a first vibration element connected to the body, and at least a second vibration element connected to the body. Additionally, at least one audio transducer may be connected to the body. The first vibration element and second vibration element may have vibration characteristics which are different from each other when compared. Additionally, the device may include a controller that is connected to a user input interface which allows the user to control the vibration elements.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

The present invention relates generally to a device used as part of an alternative healing plan for pain, brain injuries, and neurological disorders. More particularly, the invention pertains to therapeutic devices that use vibrations to provide relief from a traumatic head injury. When used in conjunction with physical exercise, supplements, brain exercises, and other holistic regimens, the user may increase blood flow circulation, stimulate the brain, help in restoring the brain to a pre-injury state, and help reduce recovery time after future injuries.

The prior art recognizes the therapeutic effects that vibration stimuli have on individuals. The use of vibration therapy can be localized to a particular part of the body, such as the arm, leg, back, neck, or head, or can also be applied to the entire body, known as whole-body vibration. For localized applications, studies have shown beneficial effects for a person suffering from acute pain when treated with localized vibration therapy. The mechanisms of therapeutic action are still not fully understood, but the effectiveness has been shown under certain conditions. Likewise, whole-body vibration has shown to have therapeutic effects including increased circulation, reduced pain, reduced fatigue, and a decrease in stress levels.

Traumatic brain injury (TBI) occurs when an external force is exerted on an individual which causes the brain to move rapidly inside the skull. External forces such as automobile accidents, falls, or contact sports, may result in such injury. Non-traumatic brain injury is the result of a medical disease or process that results in impairments to the brain. Diseases such as strokes, tumors, Alzheimer's, or dementia, can result in non-traumatic brain injury.

Considering mild traumatic brain injuries, such as concussions, rest is one of the most common treatments to allow an individual's brain to recover. Both physical and mental rest is advised so as to avoid activities that may increase, or further aggravate, any symptoms of the injury. As symptoms of the injury resolve, more activity may be enjoyed so long as the symptoms do not worsen. In addition to rest, pain relievers such as acetaminophen may be taken. Further alternative treatment options that aid in recovery from a mild traumatic brain injury are needed to provide additional opportunities to help shorten the recovery time, or help in restoring the brain to a more complete pre-injury state.

### BRIEF SUMMARY OF THE INVENTION

The present invention relates, in one embodiment, to a therapeutic vibration device. The therapeutic vibration device may include a body. The device may also include at least one first vibration element connected to the body and may also include at least one second vibration element connected to the body. The second vibration element may be configured to operate differently from the first vibration element. At least one audio transducer may be connected to the body. The body of the therapeutic vibration device may include a helmet. The body of the therapeutic vibration device may alternatively include a headband.

In one embodiment, a controller may be electrically coupled to at least one first vibration element and to at least one second vibration element. The controller may be communicatively connected to a user input interface. The user input interface may be disposed on the body or may be remote from the body. The user input interface may also include at least one selector. The user input interface may be coupled to the controller via a wired or wireless connection.

In other embodiments, the vibration device may have at least one first vibration element which is configured to operate with a first vibration characteristic. The device may also have at least one second vibration element which is configured to operate with a second vibration characteristic. The first characteristic may be different from the second vibration characteristic in some embodiments.

In one embodiment, the vibration device may include a first vibration characteristic which is configured to operate for a longer duration than the second vibration element.

In another embodiment, the vibration device may include a CPAP mask which may be connected to the body of the device.

The present invention may also relate to an embodiment having a body with at least one flexible bladder configured to be filled with a fluid that is connected to the body. Additionally, the device may have at least one vibration element disposed between the body and the flexible bladder. The fluid used to fill the bladder may be a gas.

The device may include a pump that is fluidly connected to the flexible bladder wherein the pump may be configured to at least partially fill the flexible bladder with the fluid. The pump may be electrically operated and the pump may be electrically coupled to a controller. The pump may include a two-way pump.

In one embodiment, the body may include a helmet which may be connected to the flexible bladder. In another embodiment, the body may include a headband connected to the flexible bladder.

In an embodiment, the present invention also relates to a method including activating at least one first vibration element connected to a helmet. The vibration element may have a first vibration characteristic. Additionally, the invention relates to a method including activating at least one audio transducer connected to the helmet, wherein the audio transducer is operated independently of the first vibration element.

The method may include activating at least one first vibration element connected to a helmet as part of an alternative healing regimen for a concussion sustained by the user. The method may include activating at least one first vibration element connected to a helmet as part of an alternative healing regimen for a user having a neurodegenerative disorder. The method may include activating an audio transducer to sound an alarm to notify the user at a designated time of an occurrence of an event. The method may include activating an audio transducer to play music.

Finally, the method may include activating at least one second vibration element connected to the helmet, wherein the at least one second vibration element has a second vibration characteristic. The second vibration characteristic may be different from the first vibration characteristic.

### BRIEF DESCRIPTION OF THE SEVERAL VIEWS OF THE DRAWINGS

FIG. 1 is a perspective view of an embodiment of a therapeutic vibration device as a helmet.

FIG. 2 is a bottom view of the therapeutic vibration device of FIG. 1 illustrating embodiments of the vibration elements.

FIG. 3 is a block diagram representing an embodiment of a system for controlling a vibration element in accordance with the present invention.

FIG. 4 is a block diagram representing an embodiment of vibrational elements illustrating differences in vibration frequency.

FIG. 5 is a block diagram representing an embodiment of vibrational elements illustrating differences in vibration amplitude.

FIG. 6 is a block diagram representing an embodiment of vibrational elements illustrating differences in vibration duration.

FIG. 7 is a perspective view of an embodiment of the therapeutic vibration device as a headband.

FIG. 8 is a side view of the therapeutic vibration device of FIG. 7.

FIG. 9 is a top view of the therapeutic vibration device of FIG. 7.

FIG. 10 is a perspective view of an embodiment of the therapeutic vibration device as a helmet including a CPAP mask attachment.

FIG. 11 is a flow chart representing an embodiment of a method for activating at least one vibration element.

FIG. 12 is a flow chart representing an embodiment of a method for activating at least one audio transducer.

FIG. 13 is a flow chart representing an embodiment of a method for providing alternative healing to an individual with a concussion.

FIG. 14 is a flow chart representing an embodiment of a method for providing alternative healing to an individual with a neurodegenerative disorder.

### DETAILED DESCRIPTION OF THE INVENTION

Reference will now be made in detail to embodiments of the present invention, one or more drawings of which are set forth herein. Each drawing is provided by way of explanation of the present invention and is not a limitation. In fact, it will be apparent to those skilled in the art that various modifications and variations can be made to the teachings of the present invention without departing from the scope of the disclosure. For instance, features illustrated or described as part of one embodiment can be used with another embodiment to yield a still further embodiment.

Thus, it is intended that the present invention covers such modifications and variations as come within the scope of the appended claims and their equivalents. Other objects, features, and aspects of the present invention are disclosed in, or are obvious from, the following detailed description. It is to be understood by one of ordinary skill in the art that the present discussion is a description of exemplary embodiments only and is not intended as limiting the broader aspects of the present invention.

The meanings identified below do not necessarily limit the terms, but merely provide illustrative examples for the terms. The meaning of “a”, “an”, and “the” may include plural references, and the meaning of “in” may include “in” and “on”. The phrase “in one embodiment”, as used herein does not necessarily refer to the same embodiment, although it may. The meaning of “or” may include “and” and “or”.

The term “coupled” means at least either a direct electrical connection between the connected items or an indirect connection through one or more passive or active intermediary devices.

The term “controller” as used herein may refer to, be embodied by, or otherwise include within a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. A general purpose processor can be a microprocessor, but in the alternative, the processor can be a microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without user input or prompting, whether these features, elements, and/or states are included or are to be performed in any particular embodiment.

The term “user input interface” as used herein may, unless otherwise stated, include any input-output module including, but not limited to, a device having a selector such as a button, switch, lever, dial, adjuster, knob, toggle, or the like, which, when used, sends a signal from the interface to the controller. Additionally, the “user-input interface” may also include, but is not limited to, a digital touch screen, web portal, such as individual web pages or those collectively defining a hosted website, mobile device applications, telephony interfaces such as interactive voice response, and the like.

The term “fluid” as used herein may, unless otherwise stated, include any substance that has no fixed shape including, but not limited to, a gas, liquid, semi-liquid, plasma, or any other substance that deforms under an applied shear stress.

The term “therapy” and “therapeutic” as used herein may, unless otherwise stated, include any treatment, device, behavior, regimen, intervention, remedy, and the like, to help a person feel better physically, emotionally, mentally, or otherwise from the effects of a disease or injury. Therapy may include medical treatments, but may also include holistic treatments that may be administered by the individual user or a third party.

The particular invention of this disclosure pertains to the use of alternative healing to neurological disorders, as well as traumatic and non-traumatic injuries of the brain. Vibration therapy has been shown to help increase the production of hormones associated with exercise as well as depress the response of hormones associated with stress. Pathways such as neurogenesis are thought to be involved in the beneficial effects seen through vibration therapy. Additionally, the mechanism of vibration therapy may help improve circulation through increasing the speed of blood flow. The repeated use of vibration therapy may allow for an increased supply of nutrients and oxygen rich blood to reach the brain which aids in recovery of the injury. The production of beneficial hormones and pathways such as neurogenesis not only create new neurons, but also protect existing neurons as well as the communication between them.

The neuroplasticity of a brain refers to the brain's ability, in some instances, to undergo cortical remapping in response to injury. Rehabilitation of brain injury victims, which may include activation of neuroplasticity through cortical remapping, has provided improvements in functional outcomes after injury. The use of vibration therapy in concert with other alternative healing regimens may increase functional outcomes of patients after suffering a brain injury. Further, the addition of vibration therapy may reduce recovery time and allow an individual to resume activities, or work, in a shorter amount of time. Finally, vibration therapy may provide a mechanism to restore the brain to its original, pre-injury state and thus allow the individual to resume life, at least in a cognitive sense, to before the injury occurred.

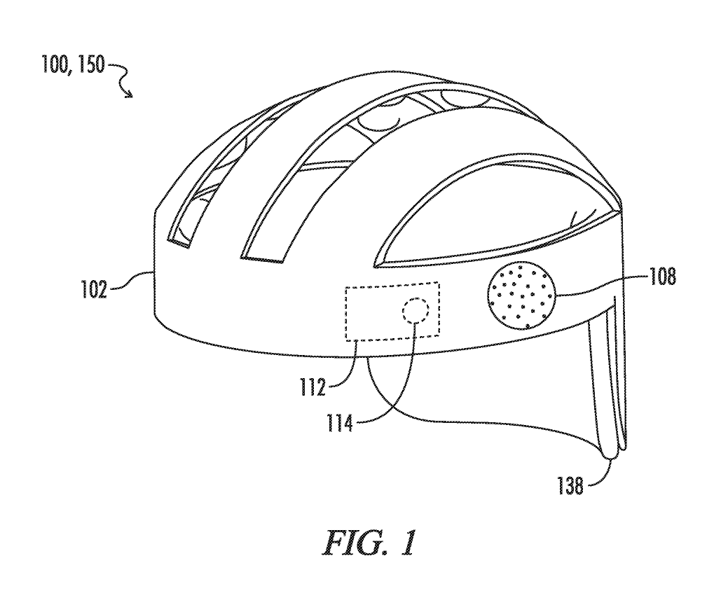

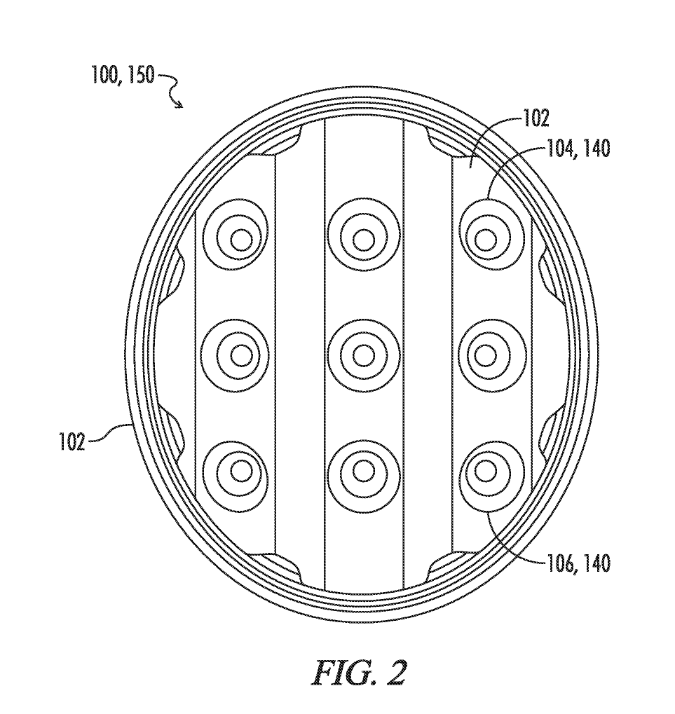

Referring initially to FIGS. 1 and 2, a therapeutic vibration device 100 may have a body 102 with at least a first vibration element 104 connected to the body 102, and at least a second vibration element 106 connected to the body 102. Additionally, at least one audio transducer 108 may be connected to the body 102. In some embodiments, the audio transducer 108 may be an audio speaker used to generate white noise which may be soothing to a user, or may be used to help a user fall asleep. The use of white noise is not limiting, but may be used for any means the user or a third party desires. A third party may include a therapist, doctor, nurse, or other party administering or providing the therapeutic services to the user.

In additional embodiments, the audio transducer 108 may be used to play music or other audible sound that is selected by the user or is determined by a third party. In other embodiments, the audio transducer 108 may be used to generate audible tones to notify the user at a designated time of an occurrence of an event, such as, a designated time to change the settings of the vibration elements. Another embodiment may include the audio transducer 108 used to play a tone to designate a time for the user to take medication associated with the holistic therapy regimen.

Referring now to FIGS. 1-2, and FIGS. 7-9, various embodiments are shown pertaining to the body 102. In one embodiment, the body 102 may be or include a helmet 150. In another embodiment, the body 102 may be or include a head band 152. Alternatively, the body 102 may be or include a cap. The body 102 may be made of any appropriate material, such as leather. In other embodiments, the body 102 may be made, in whole or in part, of metals, polymers, fabrics, or other suitable materials.

Referring specifically now to FIG. 2, in some embodiments, the device 100 may contain at least one first vibration element 104 and at least one second vibration element 106, wherein each vibration element is disposed on the body 102. In some embodiments, the body 102 may contain nineteen (19) vibration elements. In other embodiments, the body 102 may contain any number of a plurality of vibration elements. In one particular embodiment, the first vibration element 104 and second vibration element 106 are connected to the underside of the body 102 so as to contact the user directly when the device is used. The plurality of vibration elements 104, 106 may be of an appropriate number such that the majority of a user's head may be within the therapeutic region of the vibrations being produced by the vibration elements. The coverage of the majority of the user's head will allow for designated points of vibration to target a specific region of the user's head for holistic therapy. Additionally, the vibration elements 104, 106 may be positioned in a way so as to target a specific region of the user's brain to provide relief from concussions, other brain injuries, or disease states.

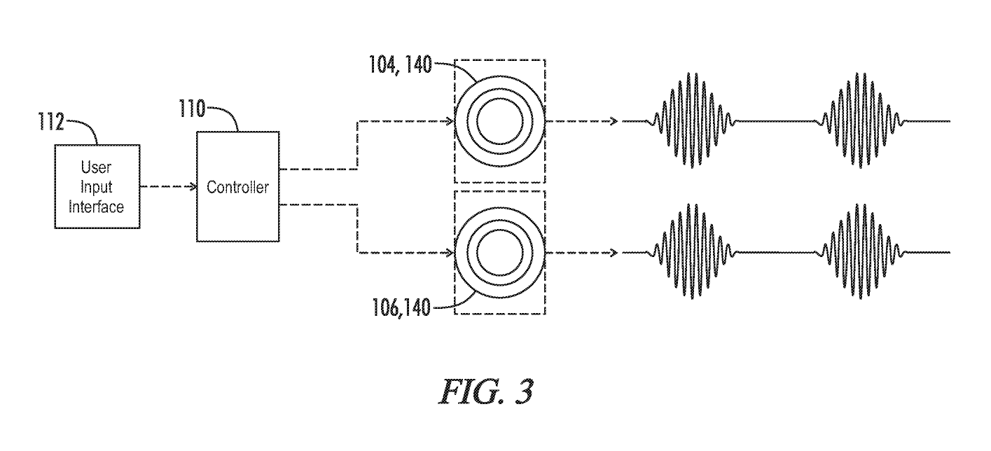

Now also referring to FIGS. 1-3, in some embodiments, the first vibration element 104 and the second vibration element 106 may be operated by a controller 110. The controller 110 may be used to operate the various vibration elements 104, 106 either in unison or may operate them individually. In one embodiment, the controller 110 may be communicatively connected to a user input interface 112 which may allow a user to operate the vibration device 100. The user input interface 112 may be disposed on the body 102. In another embodiment, the user input interface 112 may be remote from the body 102 and may be wired or wirelessly coupled to the controller 110.

The user input interface 112 may also be provided via a mobile device or other user computing device such as a desktop, laptop, tablet, or the like. In one embodiment, the user input interface 112 may be accessed through a web portal such as a website. In an embodiment using a mobile device, the user may access the user input interface 112 through a mobile application. In some embodiments, the mobile application may control the vibration characteristics and the individual vibration elements 104, 106, as well as allow the user to control the audio transducer 108. For example, the mobile application, acting as the user input interface 112, may allow a user to select playlists, or individual songs that will be played through the audio transducer 108. Additionally, the mobile app may provide reminders to the user, such as when to start and/or stop the therapeutic session, when to change the vibration to a different area of the head, or when to change the mode of vibration that is being given. Further, the mobile app may provide audible, visual, or tactile reminders to take supplements, medication, or do exercise during, before, or after the treatment session.

In certain embodiments, the user input interface 112 may incorporate at least one selector 114 which allows the user to control the vibration elements 104, 106. In some embodiments, the user input interface 112 may include a selector 114 such as, but not limited to, a button, switch, lever, dial, adjuster, knob, toggle, or the like which allows the user to control the vibration elements 104, 106. The selector 114 may be used in a variety of ways to operate the vibration elements 104, 106, or to operate the vibration device 100 in whole, or in part. In one embodiment, the selector 114 may be used to turn the vibration elements on or off. In another embodiment, the selector 114 may select one vibration element to turn on or off independently from another vibration element.

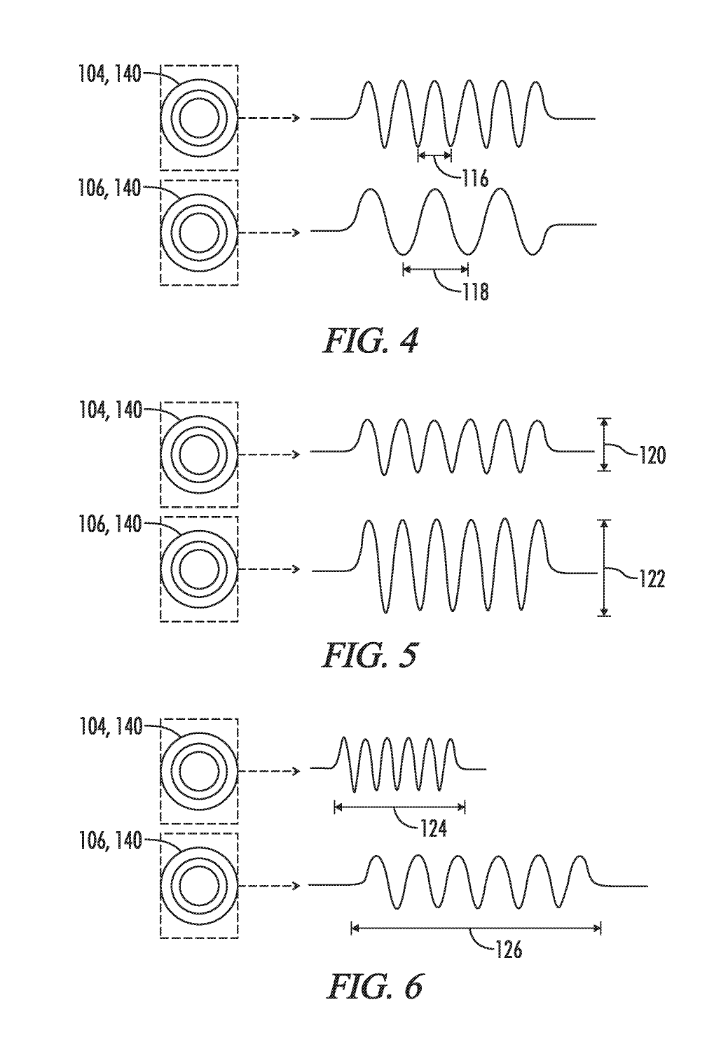

In some embodiments, the selector 114 may change the vibration characteristics of the vibration elements 104, 106. These characteristics may include, for example, vibration frequency, amplitude, or duration. Referring to FIG. 4, the first vibration element 104 may have a first vibration frequency 116, and the second vibration element 106 may have a second vibration frequency 118, and when compared, the first and second vibration frequency may be different. Likewise, FIG. 5 provides the first vibration element 104 having a first vibration amplitude 120, and the second vibration element 106 having a second vibration amplitude 122, and when compared, the first and second vibration amplitudes may be different. In FIG. 6, the first vibration element 104 may have a first duration 124, and the second vibration element 106 may have a second duration 126, and when compared, the first and second vibration durations may be different.

In certain embodiments, the controller 110 may be used by the user to manipulate any one of the vibration characteristics. In one embodiment, the selector 114 may be used to adjust a single characteristic, such as frequency, amplitude, or duration for all vibration elements 104, 106. Alternatively, the selector 114 may be configured to adjust any one single characteristic for each individual vibration element independent of any other vibration element. This embodiment would allow a user to selectively adjust the vibration characteristics for more targeted therapeutic relief of a certain region of the user's head. For example, the selector 114 may allow a user to only turn on vibration elements on the left side of the device 100 so as to target the left side of the user's head or brain regions. This may also be done for any other region of the head, or may be done for multiple regions of the head at the same time. It will be apparent to a person having ordinary skill in the art that the use of the controller 110 and user input interface 112 to selectively apply various vibrational elements 104, 106, whether the selection includes the elements being on or off, or changing the characteristics of the vibration, will result in a vast number of possibilities which increase with greater number of vibration elements connected to the body 102.

In a specific embodiment having nineteen (19) vibration elements 104, 106 connected to the body 102, each vibration element is independently controlled by the user using the user input interface 112 which is communicatively connected to the controller 110. The user may select predetermined modes of vibration, or may independently select certain vibration characteristics to be applied through each vibration element 104, 106. The predetermined modes of vibration stored within the controller may include, but are not limited to, selecting a single targeted area of the head to receive therapeutic vibration, selecting multiple targeted areas of the head, or applying certain predetermined characteristics to all of the vibration elements 104, 106. Additionally, the user may independently select, or may select from predetermined modes, certain patterns of vibration that repeat so as to create an ongoing pattern of changing vibration characteristics. In one example, the user may select between three different settings, such as low, medium, and high, with the setting referring to the frequency or amplitude individually, or together. If the settings refer to the frequency rate, then the low, medium, and high frequencies are determined relative to each other. A user may select the first setting at a given frequency (low), or may select a second setting which has a higher frequency than the first (medium), or may yet select a third setting which has an even higher frequency than the first and second (high). Similarly, the same may be accomplished for amplitude in the same manner. Additionally, as noted before, the settings of low, medium, and high, may also correlate to both frequency and amplitude together, with a low setting including a given frequency and a given amplitude, with subsequent settings (medium, high) being greater than the preceding setting(s).

Likewise, the user may increase the frequency of a single vibration element 104, 106, all vibration elements, or any combination of vibration elements, and then may also decrease the frequency. This may be done in a repetitive pattern to create a wave of increasing and decreasing vibration frequency. Likewise, this pattern may also be stored as a mode in the controller 110 and the user may select a mode which provides the wave of increasing and decreasing vibration frequency. These patterns may also be used for other characteristics and is not limited to only a single characteristic. All characteristics may be changed one at a time, changed all together, or any combination thereof. The versatility of selecting a single vibration element 104, 106, or any combination of elements, along with selecting and modifying the characteristic of each vibration element allows for targeted holistic therapy to a specific region of the brain or head in order to help heal injuries such as concussion, or disease states such as dementia, amnesia, or insomnia.

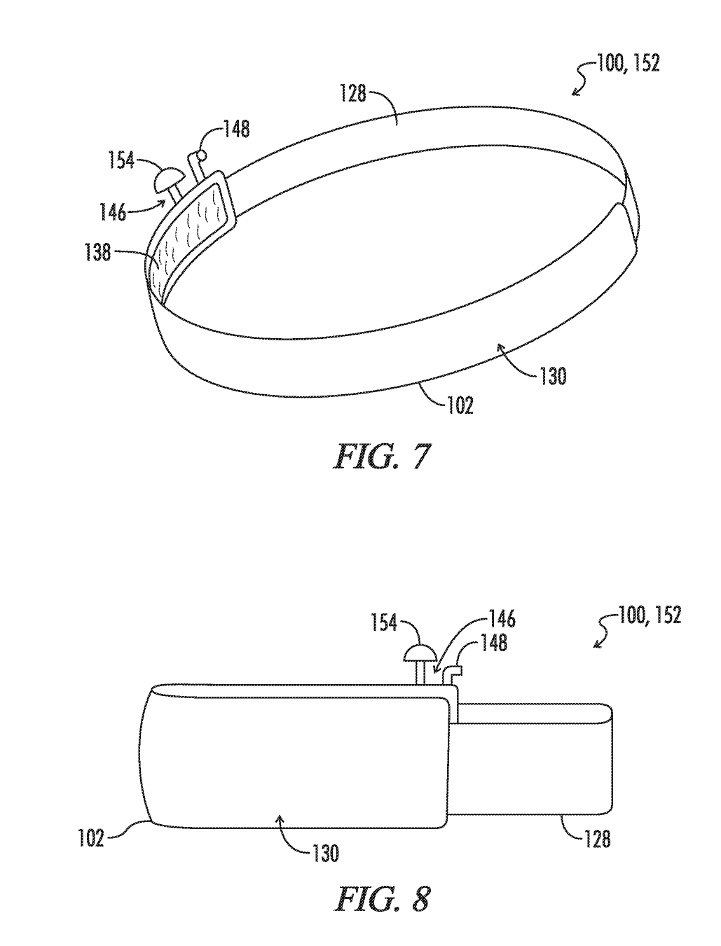

Referring to FIGS. 7-9, the body 102 may include a headband 152 to be worn around a user's head. In one embodiment, the headband 152 may be secured to a user's head using an adjustable strap 128. The adjustable strap 128 may be made of material that stretches or may be made of material that is rigid. For example, the strap 128 may be made of Spandex, Lycra, polyurethane fabric, or the like to provide adjustability due to the inherent elasticity of the fabric. Likewise, the strap 128 may be formed from a material that has minimal elasticity such as cotton, denim, linen, leather, plastic, or similar materials. The strap 128 may be mounted permanently to the body 102. Alternatively, the strap 128 may be permanently mounted only to one side of the body 102 and then connected to the other side through a fastener mechanism, for example, but not limited to, a cinch strap, hook and loop, side release buckle, top release buckle, strap buckle, or the like. Additionally, the strap 128 may be removably mounted on both sides of the body 102 to allow the strap to be removed entirely which may facilitate replacement, washing, adjustment, and the like.

In one embodiment, the headband 152 may further include a housing 130. The housing 130 may include at least one vibration element 140. In another embodiment, the housing 130 may include an insulating layer 134 that is disposed between the housing 130 and the at least one vibration element 140. The insulating layer 134 may provide, for example, noise reduction due to the at least one vibration element 140. In some embodiments, the insulating layer may be chosen from the group comprising eva foam, polyethylene foam, polyurethane foam, rubber, neoprene, PVC, and the like.

In some embodiments, the headband 152 may be worn by a user so as to locate the body 102 on the user's forehead and the strap 128 used to secure the device by extending around the back of the user's head. Alternatively, the body 102 may be made of sufficiently flexible material so as to allow the headband 152 to be placed in any configuration so as to provide therapeutic relief to a targeted region of the user's head. For example, in one embodiment, the headband 152 may be placed so as to locate the body 102 on the side of a user's head, or on the rear of the user's head, so as to provide vibration therapy to those affected areas.

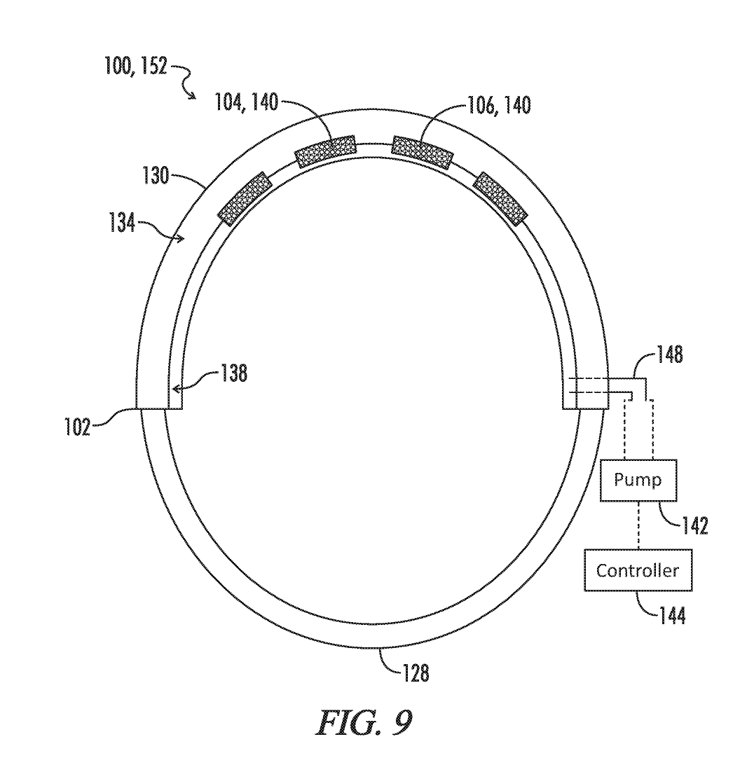

In some embodiments, the vibration device 100 may include a flexible bladder 138 connected to the body 102, the bladder is configured to be filled with a fluid. As shown in FIG. 9, in one embodiment, at least one vibration element 140 is disposed between the flexible bladder 138 and the body 102. In some embodiments, the flexible bladder 138 and at least one vibration element 140 may be connected to a body 102, including a helmet 150. Alternatively, the body 102 may include a cap. The body 102 may be made of any appropriate material, wherein one embodiment may include leather. In other embodiments, the body 102 may be made, in whole or in part, of metals, polymers, fabrics, or other suitable materials.

Referring to FIG. 7, the body 102 may include a headband 152 to be worn around a user's head. In one embodiment, the headband 152 is secured to a user's head using an adjustable strap 128. The adjustable strap 128 may be made of material that stretches or may be made of material that is rigid. In other embodiments, the headband 152 may be secured using an adjustable strap 128 and then further fitted by pressurizing or depressurizing the flexible bladder 138. A user may secure the headband 152 to the user's head with the strap 128, and then may inflate the bladder 138 using a pump 142 to fill the bladder with fluid, such as air. Upon reaching a satisfactory pressure, the user may disconnect the pump 142. In an alternative embodiment, the bladder 138 may be inflated before being secured to a user's head, and then the user or a third party may deflate the bladder 138 so as to achieve a pressure which is suitable to the user or determined by a third party, or may also be predetermined. In addition to the embodiments as described herein, prior embodiments described of the helmet 150 may also include the flexible bladder 138 connected to the body 102 as shown, for example, in FIG. 1.

In some embodiments, the bladder 138 may be filled with a fluid, for example, a gas. Alternatively, the bladder 138 may be filled with a liquid, a semi-liquid, or a semi-solid. Additionally, the body 102 may contain multiple bladders which can be inflated or deflated together, or independently, depending on the user's preferences or on the type of holistic therapy that is being given.

In one embodiment, the bladder 138 is filled with air through a pump 142 which is fluidly connected to the bladder by a connection point 148. The bladder 138 may rest against a user's head so as to create pressure for securing the device 100 to the user. The pump 142 may be used to adjust the pressure in the bladder 138 so as to reach a pressure that is determined by the user, a third party, or is predetermined. In alternative embodiments, the bladder 138 may be inflated or deflated to increase or decrease, respectively, the vibrational intensity of the at least one vibration element 140 as felt by the user through the bladder. The pump 142 may be manually actuated or may be electrically operated. Further, the pump 142 may be disposed on the body 102 or may be remote from the body.

In certain embodiments, a controller 144 may be electrically coupled to the pump 142 so as to operate the pump. The controller 144 may be the same as the controller 110 discussed above, or it may be a different or additional controller. The controller 144 may be used to turn the pump 142 on and off, or may be used to set a given pressure within the pump so as to fill the bladder 138 to a given inflated state. Additionally, the controller 144 may also be used to control the vibration characteristics. In another embodiment, the pump 142 may be configured to remove at least a portion of the fluid in the bladder 138. The pump 142 may remove a certain portion of the fluid so as to have the bladder 138 configured to an inflated state determined by the user, a third-party, or it may be predetermined.

In one embodiment, a release valve 146 may be fluidly connected to the flexible bladder 138. The release valve 146 may allow for the manual release of the fluid within the bladder 138. A user may operate the release valve 146 via a release valve button 154 to release all or a portion of the fluid within the bladder 138. In one embodiment, the user may inflate the bladder 138 to a maximum pressure, and then may use the release valve button 154 to release a portion of the fluid so as to achieve a given pressure which may be determined by the user. Alternatively, the desired pressure may be determined by a third-party.

In another embodiment, the release valve 146 may be electrically triggered so as to allow all or a portion of the fluid to be released. Additionally, the release valve 146 may also be automatically triggered upon a desired pressure of the bladder 138 being reached. The desired pressure may be determined by the user, a third-party, or be predetermined. The triggering of an automatic release valve 146 would further keep the bladder 138 from becoming over-pressurized and within a safe operating range.

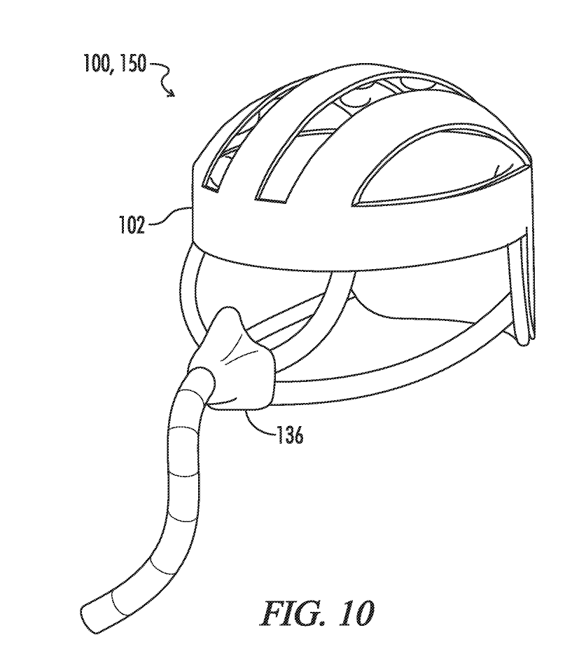

Referring now to FIG. 10, in an alternative embodiment, the vibration device 100 may further comprise attaching a continuous positive airway pressure (CPAP) mask 136 to the body 102. The CPAP mask 136 may be mounted to the body 102 through adjustable straps which allow the user to adjust the mask for comfort. Alternatively, the CPAP mask 136 may be mounted in such a way as to be detachable allowing the device 100 to be worn with or without the CPAP mask 136.

In other embodiments, additional devices, or accessories, may be attached to the vibration device. For example, a neck roll may be attached to the back of the device which provides comfort while resting the user's head against a flat surface, such as lying on a bed or while sleeping. In addition to a CPAP mask attachment, a similar BiPAP apparatus may be attached to the vibration device 100.

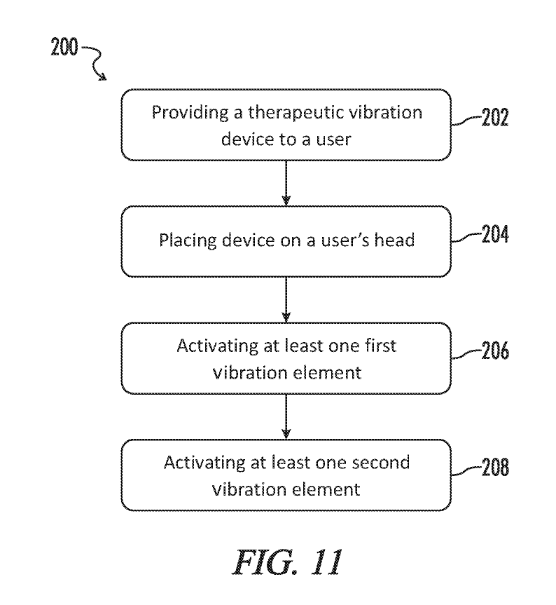

FIG. 11 is an embodiment of a method for providing therapeutic vibration in accordance with the present disclosure. The method 200 may begin at step 202 by providing a therapeutic vibration device 100 to a user, then in step 204 placing the device on the user's head. In step 206, at least one first vibration element 104 is activated. The first vibration element 104 may have a first vibration characteristic including, but not limited to, vibration frequency, amplitude, or duration. In other embodiments, step 208 may be accomplished by activating at least one second vibration element 106. The second vibration element 106 may have a second vibration characteristic including, but not limited to, vibration frequency, amplitude, or duration. Further, the second vibration characteristic may be different from the first vibration characteristic as discussed above.

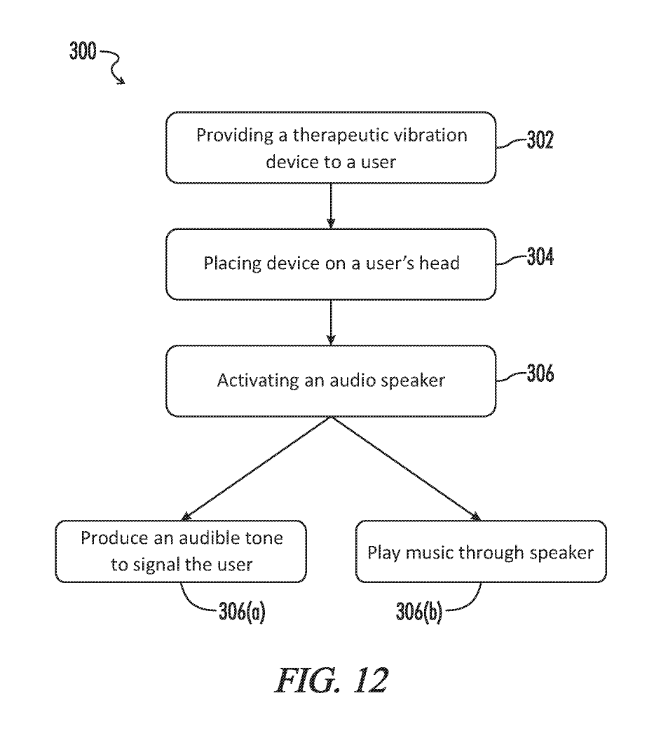

FIG. 12 is an embodiment of a method for activating an audio transducer 108 connected to a helmet 150. The method 300 may begin at step 302 by providing a therapeutic vibration device 100 to a user, then in step 304 placing the device on the user's head. In step 306, an audio transducer 108 is activated, the activation occurring independently of the at least one first vibration element 104 being activated as in step 206. In one embodiment, step 306(a) includes sounding an alarm to notify a user at a designated time of an occurrence of an event. For example, the transducer 108 may produce an audible tone which signals the user to switch to a different vibration pattern. In another example, the transducer 108 may produce an audible tone which signals the user to end the vibration use. Additionally, the transducer 108 may produce an audible tone which signals the user to take a medication at a certain time during the holistic therapeutic session.

In another embodiment, step 306(b) includes the audio transducer 108 used to play music. The music may be selected by the user, selected by a third party, or may be predetermined. The music may correspond to certain vibrational patterns or the music may be something the user finds soothing or relaxing. Additionally, the audio transducer 108 may play white noise so as to help a user fall asleep or stay asleep while undergoing holistic therapy.

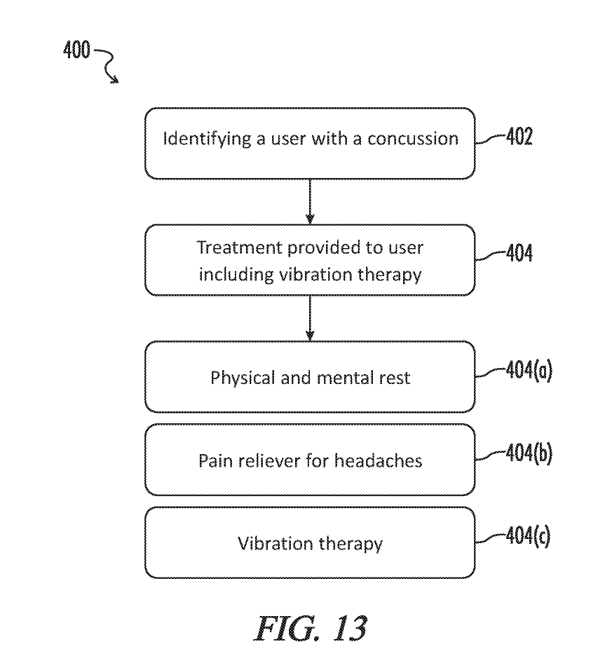

FIG. 13 is an embodiment for a method of including therapeutic vibration in an holistic regimen. The method 400 may begin at step 402 by identifying a user with a concussion. In step 404, the user undergoes alternative healing which includes vibration therapy. For example, a person sustaining a concussion may be treated by undergoing 404(a) physical and mental rest, including not doing vigorous activity, physical or mental, as well as 404(b) taking a pain reliever such as acetaminophen. The addition of vibration therapy to a targeted portion of the brain may be added as step 404(c).

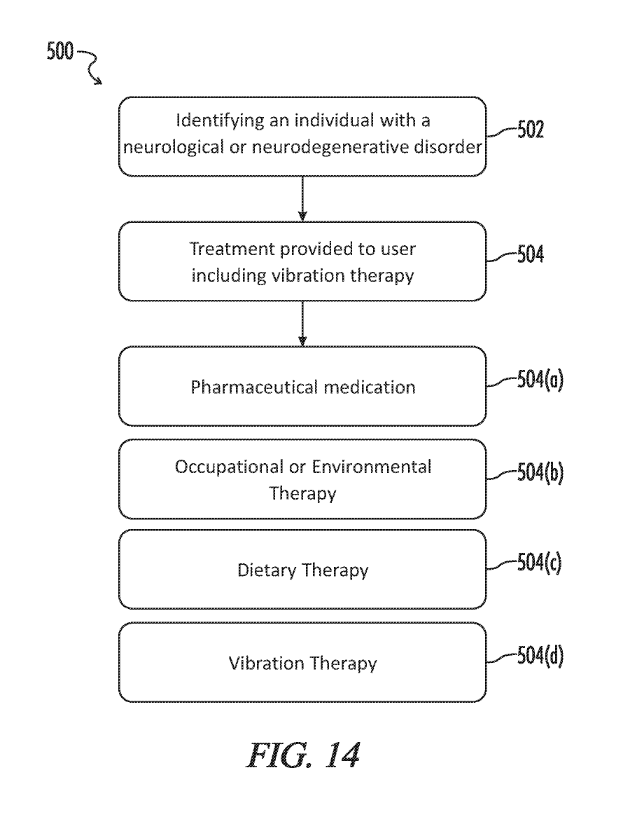

FIG. 14 is an embodiment for a method of including therapeutic vibration in an holistic regimen for neurodegenerative diseases. The method 500 may begin at step 502 by identifying a user with a neurological or neurodegenerative disorder. In step 504, the user undergoes treatment for the disorder which may include alternative healing vibration therapy. As one having skill in the art will understand, there are many holistic regimens for a large number of neurodegenerative disorders. The addition of vibration therapy may be added to any one, or all, of these holistic regimens. For example, an individual with dementia may be treated by managing symptoms with 504(a) pharmaceutical medications including, but not limited to, cholinesterase inhibitors or memantine, also by undergoing 504(b) occupational therapy or environmental therapy, and finally including 504(c) dietary therapy such as increasing intake of vitamin E or omega-3 fatty acids. The addition of 504(d) vibration therapy to such a holistic regimen may provide additional benefits to the individual.

Thus, although there have been described particular embodiments of the present invention of a new and useful THERAPEUTIC VIBRATION DEVICE AND METHOD OF USE THEREOF, it is not intended that such references be construed as limitations upon the scope of this invention except as set forth in the following claims.

What is claimed is:

1. A therapeutic vibration device comprising:
a body;
at least one first vibration element connected to the body;
at least one second vibration element connected to the body, the second vibration element configured to operate differently from the first vibration element; and
at least one audio transducer connected to the body.

2. The vibration device of claim 1, wherein the body comprises a helmet.

3. The vibration device of claim 1, wherein the body comprises a headband.

4. The vibration device of claim 1, further comprising a user input interface and a controller, wherein the controller is electrically coupled to the at least one first vibration element and the at least one second vibration element, and the controller is communicatively connected to a user input interface.

5. The vibration device of claim 4, wherein the user input interface includes at least one selector and the user input interface is disposed on the body.

6. The vibration device of claim 4, wherein the user input interface is wirelessly coupled to the controller.

7. The vibration device of claim 1, wherein:
the at least one first vibration element is configured to operate with a first vibration characteristic;
the at least one second vibration element is configured to operate with a second vibration characteristic; and
wherein the first vibration characteristic is different from the second vibration characteristic.

8. The vibration device of claim 1, wherein:
the at least one first vibration element is configured to operate for a longer duration than the at least one second vibration element.

9. The vibration device of claim 1, further comprising a continuous positive airway pressure mask connected to the body.

10. A method of providing therapeutic vibration, the method comprising:
(a) activating at least one first vibration element connected to a helmet, the at least one first vibration element having a first vibration characteristic; and
(b) activating at least one audio transducer connected to the helmet, the audio transducer operating independently of the at least one first vibration element.

11. The method of claim 10, further comprising performing step (a) as part of a holistic regimen for a concussion sustained by the user.

12. The method of claim 10, further comprising performing step (a) as part of a holistic regimen for a user having a neurodegenerative disorder.

13. The method of claim 10, wherein step (b) includes sounding an alarm to notify the user at a designated time of an occurrence of an event.

14. The method of claim 10, wherein step (b) includes playing music.

15. The method of claim 10, further comprising:
activating at least one second vibration element connected to the helmet, the at least one second vibration element having a second vibration characteristic, the second vibration characteristic being different from the first vibration characteristic.
